(19) United States
(12) Patent Application Publication
(10) Pub. No.: US 2025/0022008 A1
(43) Pub. Date: Jan. 16, 2025

(54) CAMPAIGN CONFIGURATION METHOD, APPARATUS, AND DEVICE, AND STORAGE MEDIUM

(71) Applicant: Beijing Youzhuju Network Technology Co., Ltd., Beijing (CN)

(72) Inventor: Zongqi WEI, Beijing (CN)

(21) Appl. No.: 18/770,417

(22) Filed: Jul. 11, 2024

(30) Foreign Application Priority Data
Jul. 11, 2023 (CN) 202310847292.1

(51) Int. Cl. G06Q 30/0242

(52) U.S. Cl. CPC G06Q 30/0243

(57) ABSTRACT

The present disclosure provides a campaign configuration method, apparatus, and device, and a storage medium. The method includes: displaying, in response to a select operation on a target campaign template, an element to be configured that corresponds to the target campaign template, where the element to be configured is used to represent campaign information that needs to be configured for a target campaign corresponding to the target campaign template; receiving campaign configuration information entered for the element to be configured; and generating a campaign configuration file corresponding to the target campaign based on the campaign configuration information, where the campaign configuration file is applied to a terminal on which the target campaign is deployed.

### CROSS-REFERENCE TO RELATED APPLICATION(S)

This application claims priority to Chinese Application No. 202310847292.1 filed on Jul. 11, 2023, the disclosures of which are incorporated herein by reference in its entity.

### TECHNICAL FIELD

The present disclosure relates to the field of data processing, and in particular, to a campaign configuration method, apparatus, and device, and a storage medium.

### BACKGROUND ART

In the field of e-commerce, particularly in the field of international e-commerce, campaign operation is an indispensable shelf shopping guide method. Due to some differences in culture, habit, etc. between different campaign objects, there are some differences between campaign configurations for different campaign objects.

In a current campaign configuration method, campaign configuration for campaign objects in terms of a scope, a rule, a group, and other information is generally completed by an operator based on his own understanding, lacking a standardized function of generating configuration files corresponding to different campaign objects.

### SUMMARY OF THE INVENTION

In order to solve the above technical problems, embodiments of the present disclosure provide a campaign configuration method.

According to a first aspect, the present disclosure provides a campaign configuration method. The method includes:
displaying, in response to a select operation on a target campaign template, an element to be configured that corresponds to the target campaign template, where the element to be configured is used to represent campaign information that needs to be configured for a target campaign corresponding to the target campaign template;
receiving campaign configuration information entered for the element to be configured; and
generating a campaign configuration file corresponding to the target campaign based on the campaign configuration information, where the campaign configuration file is applied to a terminal on which the target campaign is deployed.

In an optional implementation, the target campaign template is configured with a template file, page rendering information of the target campaign template on each of a plurality of pages is defined in the template file, and the displaying, in response to a select operation on a target campaign template, an element to be configured that corresponds to the target campaign template includes:
obtaining page rendering information corresponding to a first page from the template file corresponding to the target campaign template in response to the select operation on the target campaign template; and
displaying, on the first page based on the page rendering information corresponding to the first page, the element to be configured that corresponds to the target campaign template.

In an optional implementation, an information configuration module corresponding to a second page is defined in page rendering information corresponding to the second page in the plurality of pages, the information configuration module is configured with a configuration module file, an element to be configured that corresponds to the information configuration module is defined in the configuration module file, and the element to be configured is used to represent campaign information that needs to be configured for the information configuration module.

In an optional implementation, the element to be configured is configured with an element file, element rendering information of the element to be configured on each of the plurality of pages is defined in the element file, and the displaying, on the first page based on the page rendering information corresponding to the first page, the element to be configured that corresponds to the target campaign template includes:
obtaining element rendering information of the element to be configured on the first page based on the page rendering information corresponding to the first page; and
displaying the element to be configured on the first page based on the element rendering information of the element to be configured on the first page.

In an optional implementation, the method further includes:
obtaining, in response to a trigger operation for switching from the first page to a third page, element rendering information of the element to be configured on the third page from page rendering information corresponding to the third page; and
switching display from the first page to the third page, and displaying the element to be configured on the third page based on the element rendering information of the element to be configured on the third page.

In an optional implementation, before the displaying, in response to a select operation on a target campaign template, an element to be configured that corresponds to the target campaign template, the method further includes:
displaying, based on campaign application object information carried in a context injection parameter, candidate campaign templates corresponding to the campaign application object information, where the candidate campaign templates include the target campaign template, and the campaign application object information is used to represent an application object corresponding to the target campaign.

In an optional implementation, after the generating a campaign configuration file corresponding to the target campaign based on the campaign configuration information, the method further includes:
verifying, in response to a submit operation for the campaign configuration file, the campaign configuration information in the campaign configuration file based on a verification condition corresponding to the campaign application object information carried in the context injection parameter.

In an optional implementation, after the displaying, in response to a select operation on a target campaign template, an element to be configured that corresponds to the target campaign template, the method further includes:
processing, in response to a select operation on a target element to be configured, campaign configuration information corresponding to the target element to be configured, based on a linkage display mode, the verification condition, and/or a data transformation rule corresponding to the campaign application object information carried in the context injection parameter.

According to a second aspect, the present disclosure provides a campaign configuration apparatus. The apparatus includes:
a display module configured to display, in response to a select operation on a target campaign template, an element to be configured that corresponds to the target campaign template, where the element to be configured is used to represent campaign information that needs to be configured for a target campaign corresponding to the target campaign template;
a receiving module configured to receive campaign configuration information entered for the element to be configured; and
a generation module configured to generate a campaign configuration file corresponding to the target campaign based on the campaign configuration information, where the campaign configuration file is applied to a terminal on which the target campaign is deployed.

According to a third aspect, the present disclosure provides a computer-readable storage medium, where the computer-readable storage medium stores instructions therein, and the instructions, when run on a terminal device, cause the terminal device to implement the method described above.

According to a fourth aspect, the present disclosure provides a campaign configuration device. The device includes: a memory, a processor, and a computer program that is stored on the memory and runnable on the processor, where the processor, when executing the computer program, implements the method described above.

According to a fifth aspect, the present disclosure provides a computer program product. The computer program product includes a computer program/instruction. The computer program/instruction, when executed by a processor, causes the method described above to be implemented.

Compared to the prior art, the technical solutions provided in the embodiments of the present disclosure have at least the following advantages.

In the campaign configuration method provided in the embodiments of the present disclosure, the element to be configured that corresponds to the target campaign template is displayed in response to the select operation on the target campaign template, where the element to be configured is used to represent the campaign information that needs to be configured for the target campaign corresponding to the target campaign template; the campaign configuration information entered for the element to be configured is received; and the campaign configuration file corresponding to the target campaign is generated based on the campaign configuration information, where the campaign configuration file is applied to the terminal on which the target campaign is deployed.

### BRIEF DESCRIPTION OF DRAWINGS

The accompanying drawings herein, which are incorporated into and form a part of the description, illustrate the embodiments in line with the present disclosure and are used in conjunction with the description to explain a principle of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of a campaign configuration method according to an embodiment of the present disclosure;

FIG. 2 is a schematic diagram of relationships between an information configuration module and elements to be configured according to an embodiment of the present disclosure;

FIG. 3 is a schematic diagram of context information injection according to an embodiment of the present disclosure;

FIG. 4 is a schematic diagram of operations for campaign configuration according to an embodiment of the present disclosure;

FIG. 5 is a schematic diagram of a structure of a campaign configuration apparatus according to an embodiment of the present disclosure; and

FIG. 6 is a schematic diagram of a structure of a campaign configuration device according to an embodiment of the present disclosure.

### DETAILED DESCRIPTION OF THE INVENTION

For a clearer understanding of the foregoing objectives, features, and advantages of the present disclosure, the solutions of the present disclosure will be further described below. It should be noted that the embodiments in the present disclosure and features in the embodiments can be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

In the field of e-commerce, campaign operation is an indispensable shelf shopping guide method. Due to some differences in culture, habit, etc. between different campaign objects, there are some differences between campaign configurations for different campaign objects.

In a current campaign configuration method, campaign configuration for campaign objects in terms of a scope, a rule, a group, and other information is generally completed by an operator based on his own understanding, lacking a standardized function of generating configuration files corresponding to different campaign objects.

To this end, the embodiments of the present disclosure provide a campaign configuration method. An element to be configured that corresponds to a target campaign template is displayed in response to a select operation on the target campaign template, where the element to be configured is used to represent campaign information that needs to be configured for a target campaign corresponding to the target campaign template. Campaign configuration information entered for the element to be configured is received. A campaign configuration file corresponding to the target campaign is generated based on the campaign configuration information, where the campaign configuration file is applied to a terminal on which the target campaign is deployed. As can be seen, in the embodiments of the present disclosure, information to be configured that corresponds to the target campaign is displayed on the target campaign template, so that a user may enter the campaign configuration information for the information to be configured, to generate the campaign configuration file corresponding to the target campaign. In this way, a standardized function for generating the campaign configuration file is implemented.

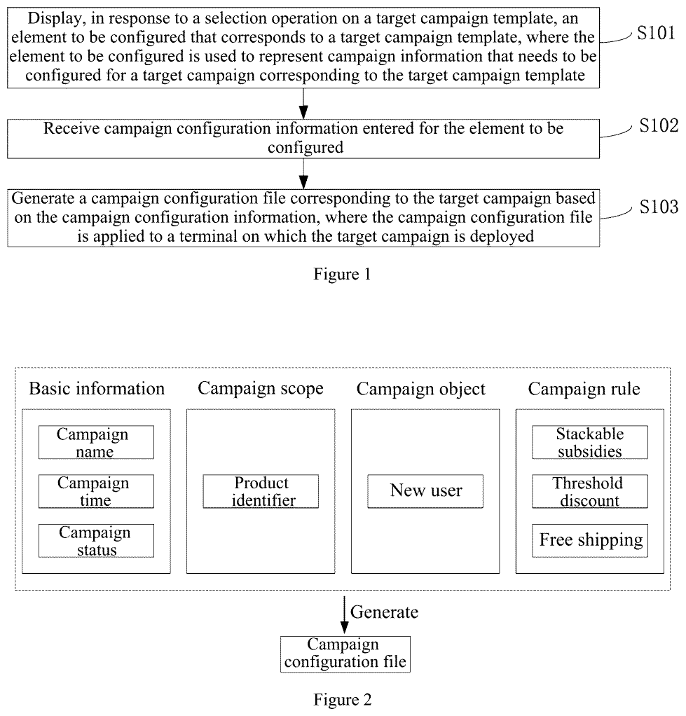

Based on this, an embodiment of the present disclosure provides a campaign configuration method. FIG. 1 is a flowchart of the campaign configuration method according to this embodiment of the present disclosure. The method specifically includes the following steps.

S101: Display, in response to a select operation on a target campaign template, an element to be configured that corresponds to the target campaign template.

The element to be configured is used to represent campaign information that needs to be configured for a target campaign corresponding to the target campaign template.

The campaign configuration method provided in this embodiment of the present disclosure is applicable to a client. For example, the client may include a client deployed on a smartphone, a client deployed on a tablet computer, etc.

In this embodiment of the present disclosure, the target campaign template may be a standardized template created in advance based on the campaign information that needs to be configured for the target campaign, and a user may configure, based on the element to be configured that is displayed on the target campaign template, the campaign information that needs to be configured for the target campaign. The target campaign is, for example, an international e-commerce marketing campaign. A type of the target campaign is not limited in this embodiment of the present disclosure.

In this embodiment of the present disclosure, the element to be configured that corresponds to the target campaign template may be used to represent the campaign information required for the target campaign. The element to be configured may include a campaign name, a campaign time, a target user, a campaign area, etc.

In an optional implementation, the select operation on the target campaign template may include a click operation acting on the target campaign template, etc. For example, in a process of displaying a plurality of campaign templates on a list page, the element to be configured that corresponds to the target campaign template may be displayed after triggering by the click operation acting on the target campaign template, where the target campaign template may be any one of the plurality of campaign templates.

S102: Receive campaign configuration information entered for the element to be configured.

In this embodiment of the present disclosure, the campaign configuration information is used to generate a campaign configuration file corresponding to the target campaign.

In an optional implementation, when the select operation on the target campaign template is received, the element to be configured that corresponds to the target campaign template may be displayed in a form of a form page, and an input box or a tab for the element to be configured is displayed at a preset position of the element to be configured, so that the user (for example, an operator) may enter, based on the input box or the tab, the campaign configuration information for the element to be matched.

In this embodiment of the present disclosure, in a process of displaying the element to be configured that corresponds to the target campaign template, the campaign configuration information entered by the user (for example, the operator) for the element to be configured may be received, so that the corresponding campaign configuration file may be generated subsequently based on the campaign configuration information.

S103: Generate the campaign configuration file corresponding to the target campaign based on the campaign configuration information.

The campaign configuration file is applied to a terminal on which the target campaign is deployed.

In this embodiment of the present disclosure, after the campaign configuration information entered by the user for the element to be configured is received, the campaign configuration file corresponding to the target campaign may be generated based on the received campaign configuration information, and subsequently, the generated campaign configuration file may be applied to the terminal on which the target campaign is deployed, so that the terminal on which the target campaign is deployed can display the campaign based on the campaign configuration file.

In this embodiment of the present disclosure, the campaign configuration file is used to describe a campaign process of the target campaign corresponding to the target campaign template.

In the campaign configuration method provided in this embodiment of the present disclosure, the element to be configured that corresponds to the target campaign template is displayed in response to the select operation on the target campaign template, where the element to be configured is used to represent the campaign information that needs to be configured for the target campaign corresponding to the target campaign template; the campaign configuration information entered for the element to be configured is received; and the campaign configuration file corresponding to the target campaign is generated based on the campaign configuration information, where the campaign configuration file is applied to the terminal on which the target campaign is deployed. As can be seen, in the embodiments of the present disclosure, information to be configured that corresponds to the target campaign is displayed on the target campaign template, so that a user may enter the campaign configuration information for the information to be configured, to generate the campaign configuration file corresponding to the target campaign. In this way, a standardized function for generating the campaign configuration file is implemented.

In practical application, in the process of displaying the element to be configured that corresponds to the target campaign template upon receiving the select operation on the target campaign template, it is required to perform page rendering on a first page corresponding to the target campaign template, so as to achieve an effect of displaying, on the first page, the element to be configured that corresponds to the target campaign template.

In this embodiment of the present disclosure, the target campaign template is pre-configured with a template file, and the template file may be used to describe the campaign information that needs to be configured for the target campaign corresponding to the target campaign template.

In an optional implementation, the campaign information that needs to be configured for the target campaign corresponding to the target campaign template may be described with a domain-specific language (DSL), so that the campaign configuration file corresponding to the target campaign can be generated subsequently based on the campaign configuration information entered for the campaign information (i.e., the element to be configured) that needs to be configured. The DSL, such as JSON, SQL, and a regular expression, is a programming language or specification language that is easy for people to understand, and may be interpreted and executed by a computer. It is worth noting that the DSL language used for configuring the template file for the target campaign template in this embodiment of the present disclosure is the JSON language.

Javascript Object Notation (JSON) is a lightweight data exchange format that is based on a subset of the ECMAScript specification, and stores and represents data using a text format completely independent of the programming language. A simple and clear hierarchical structure makes JSON an ideal data exchange language. The JSON language is easy for people to read and write and also easy for machines to parse and generate, and effectively improves network transmission efficiency.

In this embodiment of the present disclosure, since there are some differences in display effects or display styles of the target campaign template on different pages, in a process of configuring the template file corresponding to the target campaign template, it is also required to define, in the template file, page rendering information of the target campaign template on each of a plurality of pages.

In this embodiment of the present disclosure, the page rendering information of the target campaign template on each of the plurality of pages is used for parsing to generate a corresponding page route. A display page corresponding to the target campaign template may include a list page, a form page, a details page, etc.

For example, assuming that the template file is named Template, the page rendering information of the target campaign template on each of the plurality of pages is defined in the template file Template. The page information on the plurality of pages may be, for example, fields listRender, formRender, and viewRender. The field listRender is used to describe page rendering information of the target campaign template on the list page, and the page rendering information is used for parsing to generate a list page route. The field formRender is used to describe page rendering information of the target campaign template on the form page, and the page rendering information is used for parsing to generate a form page route. The field viewRender is used to describe page rendering information of the target campaign template on the details page, and the page rendering information is used for parsing to generate a details page route.

In addition, a name, a route prefix, an identifier, etc. corresponding to the target campaign template may also be defined in the template file Template. For example, a field name may be used to describe the name of the target campaign template. A field route may be used to describe a route prefix, and specifically, URLs of the list page, the details page, etc. corresponding to the target campaign template may be generated based on a front-end routing principle. A field templateKey may be used to describe the identifier of the target campaign template, and the identifier may be used to uniquely distinguish the target campaign corresponding to the target campaign template.

In an optional implementation, displaying, in response to the select operation on the target campaign template, the element to be configured that corresponds to the target campaign template may include: obtaining, page rendering information corresponding to a first page from the template file corresponding to the target campaign template in response to the select operation on the target campaign template, and displaying, on the first page based on the page rendering information corresponding to the first page, the element to be configured that corresponds to the target campaign template.

In this embodiment of the present disclosure, the first page may be any page. For example, the first page may be any one of the list page, the form page, and the details page.

Since the page rendering information of the target campaign template on the list page (assuming that the first page is the list page) is defined in the template file Template, when the select operation performed by the user for the target campaign template is received, the page rendering information listRender corresponding to the list page may be obtained from the template file based on a page rendering information identifier, and then the element to be configured that corresponds to the target campaign template is displayed on the list page based on the page rendering information listRender.

In an optional implementation, an information configuration module corresponding to a second page is defined in page rendering information corresponding to the second page in the plurality of pages. The information configuration module may include a basic campaign information module, a campaign object module, a campaign scope module, a campaign condition module, a campaign rule module, a campaign display module, etc.

For example, assuming that the page rendering information corresponding to the second page is named listRender and the information configuration module corresponding to the second page is named Workflow, the information configuration module Workflow corresponding to the second page is defined in the page rendering information listRender corresponding to the second page. The field listRender is used to describe the page rendering information of the target campaign template on the list page, and a field workflow is used to describe an information configuration module corresponding to the list page.

In this embodiment of the present disclosure, there is a correspondence between the information configuration module and the element to be configured. FIG. 2 is a schematic diagram of a relationship between the information configuration module and the element to be configured according to this embodiment of the present disclosure. Specifically, a new user exclusive coupon is used as an example, in which elements to be configured that correspond to the basic information module are respectively the campaign name, the campaign time, and a campaign status, an element to be configured that corresponds to the campaign scope module is a product identifier, an element to be configured that corresponds to the campaign object module is a new user, and elements to be configured that correspond to the campaign rule module are respectively stackable subsidies, a threshold discount, and free shipping.

In this embodiment of the present disclosure, the second page and the first page may be the same page or different pages.

In this embodiment of the present disclosure, the information configuration module is configured with a configuration module file, an element to be configured that corresponds to the information configuration module is defined in the configuration module file, and the element to be configured is used to represent campaign information that needs to be configured for the information configuration module.

For example, assuming that the configuration module file is named Workflow and the element to be configured is named element, the element to be configured element corresponding to the information configuration module is defined in the configuration module file Workflow. A field element is used to describe the element to be configured that corresponds to the information configuration module, for example, the campaign name, the campaign object, or the campaign area.

In addition, a display mode, a name, etc. of the information configuration module may also be defined in the configuration module file Workflow. For example, a field type may be used to describe the display mode of the information configuration module. Specifically, default may be used to indicate that information configuration module is arranged and displayed in order, bottom is used to indicate that the information configuration module is arranged and displayed at the bottom of a page, a field label is used to describe the name of the information configuration module, such as basic information, a campaign scope, a campaign object, or a campaign rule, and a field customProps is used to describe a customized style of the information configuration module.

In this embodiment of the present disclosure, an information configuration module corresponding to the first page is defined in the page rendering information corresponding to the first page (assuming that the first page and the second page are the same page), and the element to be configured that corresponds to the information configuration module is defined in the configuration module file. Therefore, in a process of rendering the first page, the first page may be rendered based on the configuration module file and the element to be configured that is defined in the configuration module file.

In practical application, in a process of defining the element to be configured in the configuration module file, the element to be configured may be configured with an element file, and the element file is used to describe element rendering information of the element to be configured on each of the plurality of pages.

For example, assuming that the element file is named Element, the element rendering information of the element to be configured on each of the plurality of pages is defined in the element file Element. The element rendering information may be, for example, fields listRender, formRender, viewRender. The field formRenderer is used to describe element rendering information of the element to be configured on the form page. The field listRenderer is used to describe element rendering information of the element to be configured on the list page. The field viewRenderer is used to describe element rendering information of the element to be configured on the details page.

In addition, a display name of the element to be configured on each page may also be defined in the element file Element. For example, a field label may be used to describe the display names of the element to be configured on the plurality of pages, such as display names on the list page, the form page, and the details page, and a field field may be used to describe a field of the element to be configured on each page.

In an optional implementation, displaying, on the first page based on the page rendering information corresponding to the first page, the element to be configured that corresponds to the target campaign template may include: obtaining element rendering information of the element to be configured on the first page based on the page rendering information corresponding to the first page; and displaying the element to be configured on the first page based on the element rendering information of the element to be configured on the first page.

The page rendering information (for example, listRender, formRender, viewRender) corresponding to the first page is defined in the template file Template, the configuration module file Workflow corresponding to the first page (assuming that the second page and the first page are the same page) is defined in the page rendering information, and the element file Element is defined in the configuration module file. Therefore, when the select operation performed by the user for the target campaign template is received, the page rendering information corresponding to the first page, for example, the page rendering information listRender corresponding to the list page, is first obtained from the template file based on the page rendering information identifier. Then, the element rendering information of the element to be configured on the first page is obtained based on the element file Element defined in the page rendering information listRender. Finally, the element to be configured is displayed on the first page based on the element rendering information of the element to be configured on the first page, so that after the campaign configuration information entered for the element to be configured is received subsequently, the campaign configuration file corresponding to the target campaign is generated based on the campaign configuration information.

In an optional implementation, when a trigger operation for switching from the first page to a third page is received, element rendering information of the element to be configured on the third page is obtained from page rendering information corresponding to the third page. Then, the display is switched from the first page to the third page, and the element to be configured is displayed on the third page based on the element rendering information of the element to be configured on the third page.

In this embodiment of the present disclosure, the first page and the third page may be different pages. For example, the first page may be the list page, and the third page may be the details page or the form page.

As can be seen, in the embodiments of the present disclosure, information to be configured that corresponds to the target campaign is displayed on the target campaign template, so that a user may enter the campaign configuration information for the information to be configured, to generate the campaign configuration file corresponding to the target campaign. In this way, a standardized function for generating the campaign configuration file is implemented.

In practical application, campaign application object information is usually used in a process of describing the target campaign based on the DSL. Since the campaign application object information is context information, it is required to obtain the campaign application object information in page display, component display, and even linkage display scenarios, to improve the accuracy of the campaign application object information obtained in the page display, component display, linkage display, and other scenarios.

In this embodiment of the present disclosure, the campaign application object information is abstracted into a context injection parameter, so that when a select operation for a candidate campaign template is received subsequently, the candidate campaign template corresponding to the campaign application object information carried in the context injection parameter can be displayed based on the campaign application object information.

In this embodiment of the present disclosure, the candidate campaign templates may include a plurality of campaign templates, and the target campaign template may be any one of the candidate campaign templates.

In this embodiment of the present disclosure, the campaign application object information may include a tenant, an effective region, etc. corresponding to the campaign. The tenant corresponding to the campaign is specifically used to represent an application where the campaign is carried out. The effective region corresponding to the campaign may be used to represent an effective region, etc. of the application where the campaign is carried out. For example, different effective regions may correspond to different countries, or different effective regions may correspond to different cities, etc.

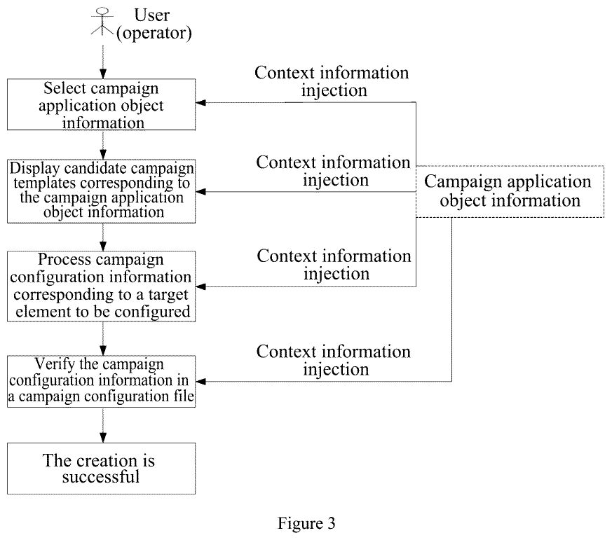

FIG. 3 is a schematic diagram of context information injection according to an embodiment of the present disclosure. After the user selects the tenant corresponding to the campaign and the effective region of the application where the campaign is carried out, the tenant and the effective region are abstracted into the context injection parameter, so that candidate campaign templates corresponding to the tenant and the effective region are displayed based on the tenant and the effective region that are carried in the context injection parameter.

In an optional implementation, a correspondence between campaign application object information and a candidate campaign template may be established in advance, so that after the user selects the campaign application object information, the candidate campaign template corresponding to the campaign application object information can be displayed to the user based on the correspondence.

In an optional implementation, to further improve the accuracy of the campaign application object information obtained in the page display, component display, linkage display, and other scenarios, at least one of a linkage display mode, a verification condition, and a data transformation rule corresponding to the campaign application object information may also be carried in the context injection parameter, so that after the element to be configured that corresponds to the target campaign template is displayed, campaign configuration information corresponding to a target element to be configured may further be processed based on at least one of the linkage display mode, the verification condition, and the data transformation rule corresponding to the campaign application object information in response to a select operation on the target element to be configured.

The linkage display mode may be used to describe a display relationship between a plurality of elements to be configured. For example, after the user selects a live streaming type as a target restriction type, a type corresponding to a creator having a display relationship with the target restriction type is highlighted, in which case the user does not need to select the type corresponding to the creator. The verification condition is used to describe restriction scope information of the element to be configured.

As shown in FIG. 3, after the candidate campaign templates corresponding to the tenant and the effective region are displayed based on the tenant and the effective region that are carried in the context injection parameter, the tenant and the effective region are abstracted into the context injection parameter again when the select operation on the target element to be configured is received, and then the campaign configuration information corresponding to the target element to be configured is processed based on a linkage display mode, a verification condition, and/or a data transformation rule corresponding to the tenant and the effective region carried in the context injection parameter. Therefore, the accuracy of the campaign application object information obtained in the page display, component display, linkage display, and other scenarios is further improved.

In practical application, the verification condition corresponding to the campaign application object information may further be carried in the context injection parameter. The campaign application object information is used to perform service logic verification on an interactive object corresponding to the target campaign.

After the campaign configuration file corresponding to the target campaign is generated based on the campaign configuration information, when a submit operation performed by the user for the campaign configuration file is received, it is further required to verify the campaign configuration information in the campaign configuration file based on the verification condition corresponding to the campaign application object information carried in the context injection parameter.

In this embodiment of the present disclosure, the submit operation for the campaign configuration file may include a trigger operation on a submit control on the form page, etc.

For example, in a scenario of a new user exclusive coupon, assuming that the effective region corresponding to the target campaign is Indonesia and the verification condition corresponding to the campaign application object information carried in the context injection parameter is a subsidy rate no more than 30%, when the submit operation performed by the user for the campaign configuration file is received, the campaign configuration information, i.e., the subsidy rate, in the campaign configuration file is verified. If the subsidy rate is 20% (i.e., no more than 30%), it indicates that the campaign configuration file is applicable to the terminal on which the target campaign is deployed; or if the subsidy rate is 40% (i.e., exceeding 30%), it indicates that the campaign configuration file is not applicable to the terminal on which the target campaign is deployed.

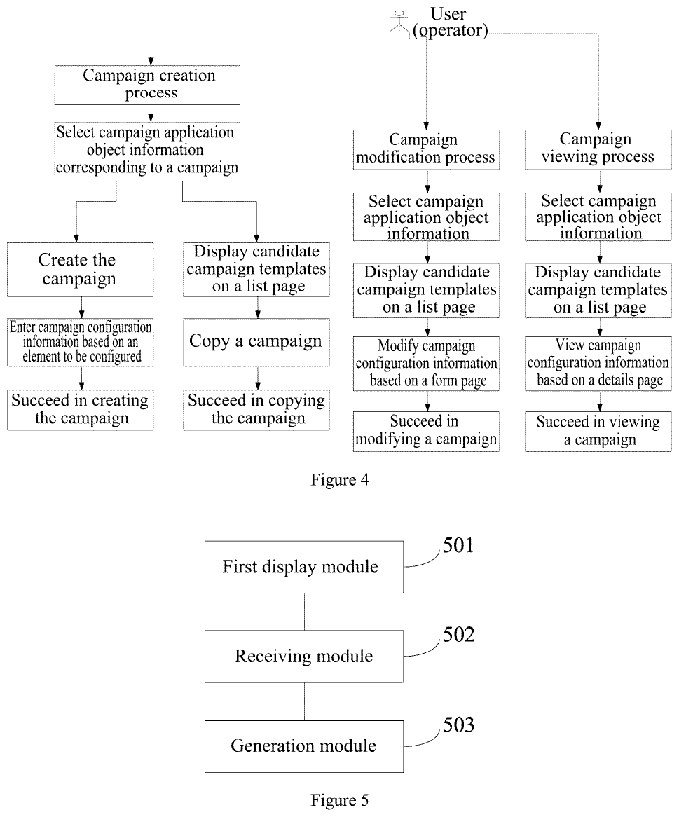

FIG. 4 is a schematic diagram of operations for campaign configuration according to an embodiment of the present disclosure. The operations for the campaign configuration include three processes: campaign creation, campaign modification, and campaign viewing.

In the campaign creation process, the user (for example, the operator) first selects the campaign application object information corresponding to the campaign. The campaign application object information may include the tenant corresponding to the campaign, the effective region of the application where the campaign is carried out, etc. The tenant corresponding to the campaign is specifically used to represent the application where the campaign is carried out.

After the user selects the campaign application object information corresponding to the campaign, the candidate campaign template corresponding to the campaign application object information is displayed on the list page. On this basis, in an optional implementation, when a trigger operation performed by the user on a campaign creation button displayed on the list page is received, a jump is made from the list page to the form page, and the element to be configured that corresponds to the target campaign template is displayed on the form page. The user may enter the campaign configuration information based on the element to be configured, so that the campaign configuration file corresponding to the target campaign is generated based on the campaign configuration information.

In another optional implementation, when a copy operation performed by the user on the target campaign template in the candidate campaign templates is received, a jump is made from the list page to the form page, and the element to be configured that corresponds to the target campaign template is displayed on the form page. The user may enter the campaign configuration information based on the element to be configured, so that the campaign configuration file corresponding to the target campaign is generated based on the campaign configuration information.

In the campaign modification process, the user first selects the campaign application object information corresponding to the campaign, and after the user selects the campaign application object information corresponding to the campaign, the candidate campaign template corresponding to the campaign application object information is displayed on the list page. In an optional implementation, when an edit operation performed by the user for the target campaign template in the candidate campaign templates is received, a jump is made from the list page to the form page, and the element to be configured that corresponds to the target campaign template is displayed on the form page. The user may modify, based on the form page, the campaign configuration information corresponding to the element to be configured, so that the campaign configuration file corresponding to the target campaign is generated based on modified campaign configuration information.

In the campaign viewing process, the user first selects the campaign application object information corresponding to the campaign, and after the user selects the campaign application object information corresponding to the campaign, the candidate campaign template corresponding to the campaign application object information is displayed on the list page. In an optional implementation, when a viewing operation performed by the user on the target campaign template in the candidate campaign templates displayed on the list page is received, a jump is made from the list page to the details page, and the element to be configured that corresponds to the target campaign template is displayed on the details page for the user to view.

In an operation process of the campaign configuration according to this embodiment of the present disclosure, the information to be configured that corresponds to the target campaign is displayed on the target campaign template, so that the user may enter the campaign configuration information for the information to be configured, to generate the campaign configuration file corresponding to the target campaign. In this way, the standardized function for generating the campaign configuration file is implemented.

Based on the above method embodiment, the present disclosure further provides a campaign configuration apparatus. FIG. 5 is a schematic diagram of a structure of the campaign configuration apparatus according to an embodiment of the present disclosure. The apparatus includes:
a first display module 501 configured to display, in response to a select operation on a target campaign template, an element to be configured that corresponds to the target campaign template, where the element to be configured is used to represent campaign information that needs to be configured for a target campaign corresponding to the target campaign template;
a receiving module 502 configured to receive campaign configuration information entered for the element to be configured; and
a generation module 503 configured to generate a campaign configuration file corresponding to the target campaign based on the campaign configuration information, where the campaign configuration file is applied to a terminal on which the target campaign is deployed.

In an optional implementation, the target campaign template is configured with a template file, page rendering information of the target campaign template on each of a plurality of pages is defined in the template file, and the first display module includes:
a first obtaining sub-module configured to obtain page rendering information corresponding to a first page from the template file corresponding to the target campaign template in response to the select operation on the target campaign template; and
a display sub-module configured to display, on the first page based on the page rendering information corresponding to the first page, the element to be configured that corresponds to the target campaign template.

In an optional implementation, an information configuration module corresponding to a second page is defined in page rendering information corresponding to the second page in the plurality of pages, the information configuration module is configured with a configuration module file, an element to be configured that corresponds to the information configuration module is defined in the configuration module file, and the element to be configured is used to represent campaign information that needs to be configured for the information configuration module.

In an optional implementation, the element to be configured is configured with an element file, element rendering information of the element to be configured on each of the plurality of pages is defined in the element file, and the display sub-module is specifically configured to:
obtain element rendering information of the element to be configured on the first page based on the page rendering information corresponding to the first page; and
display the element to be configured on the first page based on the element rendering information of the element to be configured on the first page.

In an optional implementation, the first display module further includes:
a second obtaining sub-module configured to obtain, in response to a trigger operation for switching from the first page to a third page, element rendering information of the element to be configured on the third page from page rendering information corresponding to the third page; and
a display switching sub-module configured to switch display from the first page to the third page, and display the element to be configured on the third page based on the element rendering information of the element to be configured on the third page.

In an optional implementation, the apparatus further includes:
a second display module configured to display, based on campaign application object information carried in a context injection parameter, a candidate campaign template corresponding to the campaign application object information, where the candidate campaign templates include the target campaign template, and the campaign application object information is used to represent an application object corresponding to the target campaign.

In an optional implementation, the apparatus further includes:
a verification module configured to verify, in response to a submit operation for the campaign configuration file, the campaign configuration information in the campaign configuration file based on a verification condition corresponding to the campaign application object information carried in the context injection parameter.

In an optional implementation, the apparatus further includes:
a processing module configured to process, in response to a select operation on a target element to be configured, campaign configuration information corresponding to the target element to be configured, based on a linkage display mode, the verification condition, and/or a data transformation rule corresponding to the campaign application object information carried in the context injection parameter.

In the campaign configuration method provided in this embodiment of the present disclosure, the element to be configured that corresponds to the target campaign template is displayed in response to the select operation on the target campaign template, where the element to be configured is used to represent the campaign information that needs to be configured for the target campaign corresponding to the target campaign template; the campaign configuration information entered for the element to be configured is received; and the campaign configuration file corresponding to the target campaign is generated based on the campaign configuration information, where the campaign configuration file is applied to the terminal on which the target campaign is deployed. As can be seen, in the embodiments of the present disclosure, information to be configured that corresponds to the target campaign is displayed on the target campaign template, so that a user may enter the campaign configuration information for the information to be configured, to generate the campaign configuration file corresponding to the target campaign. In this way, a standardized function for generating the campaign configuration file is implemented.

In addition to the method and apparatus described above, an embodiment of the present disclosure further provides a computer-readable storage medium. The computer-readable storage medium stores instructions therein. The instructions, when run on a terminal device, cause the terminal device to implement the campaign configuration method described in the embodiments of the present disclosure.

An embodiment of the present disclosure further provides a computer program product. The computer program product includes a computer program/instruction. The computer program/instruction, when executed by a processor, causes the campaign configuration method described in the embodiments of the present disclosure to be implemented.

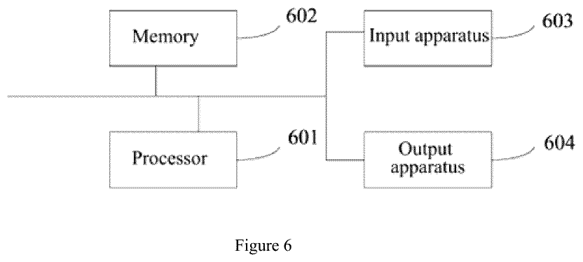

In addition, an embodiment of the present disclosure further provides a campaign configuration device. With reference to FIG. 6, the device may include: a processor 601, a memory 602, an input apparatus 603, and an output apparatus 604. There may be one or more processors 601 in the campaign configuration device. For example, there is one processor in FIG. 6. In some embodiments of the present disclosure, the processor 601, the memory 602, the input apparatus 603, and the output apparatus 604 may be connected through a bus or in another manner. For example, they are connected through the bus in FIG. 6.

The memory 602 may be configured to store software programs and modules. The processor 601 executes various functional applications and data processing of the campaign configuration device by running the software programs and modules stored in the memory 602. The memory 602 may mainly include a program storage area and a data storage area. The program storage area may store an operating system, an application required for at least one function, etc. In addition, the memory 602 may include a high-speed random access memory and may further include a non-volatile memory, such as at least one magnetic disk storage device, a flash memory device, or other volatile solid-state storage devices. The input apparatus 603 may be configured to receive entered numerical or character information, and generate a signal input related to a user setting and function control of the campaign configuration device.

Specifically, in this embodiment, the processor 601 loads an executable file corresponding to a process of one or more applications into the memory 602 in accordance with the following instructions, and the processor 601 runs the application stored in the memory 602, so as to implement various functions of the above campaign configuration device.

It should be noted that, herein, relative terms such as “first” and “second” are only used to distinguish one entity or operation from another entity or operation, and do not necessarily require or imply that such an actual relationship or order exists between these entities or operations. Moreover, the terms “include”, “comprise”, or any other variants thereof are intended to cover a non-exclusive inclusion, so that a process, a method, an article, or a device that includes a list of elements not only includes those elements but also includes other elements that are not listed, or further includes elements inherent to such a process, method, article, or device. In the absence of more restrictions, an element defined by “including a . . . ” does not exclude another same element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure is not limited to the embodiments described herein but is to be accorded the broadest scope consistent with the principle and novel features disclosed herein.

1. A campaign configuration method, comprising:
displaying, in response to a select operation on a target campaign template, an element to be configured that corresponds to the target campaign template, wherein the element to be configured is used to represent campaign information that needs to be configured for a target campaign corresponding to the target campaign template;
receiving campaign configuration information entered for the element to be configured; and
generating a campaign configuration file corresponding to the target campaign based on the campaign configuration information, wherein the campaign configuration file is applied to a terminal on which the target campaign is deployed.

2. The method according to claim 1, wherein the target campaign template is configured with a template file, page rendering information of the target campaign template on each of a plurality of pages is defined in the template file, and the displaying, in response to a select operation on a target campaign template, an element to be configured that corresponds to the target campaign template comprises:
obtaining page rendering information corresponding to a first page from the template file corresponding to the target campaign template in response to the select operation on the target campaign template; and
displaying, on the first page based on the page rendering information corresponding to the first page, the element to be configured that corresponds to the target campaign template.

3. The method according to claim 2, wherein an information configuration module corresponding to a second page is defined in page rendering information corresponding to the second page in the plurality of pages, the information configuration module is configured with a configuration module file, an element to be configured that corresponds to the information configuration module is defined in the configuration module file, and the element to be configured is used to represent campaign information that needs to be configured for the information configuration module.

4. The method according to claim 2, wherein the element to be configured is configured with an element file, element rendering information of the element to be configured on each of the plurality of pages is defined in the element file, and the displaying, on the first page based on the page rendering information corresponding to the first page, the element to be configured that corresponds to the target campaign template comprises:
obtaining element rendering information of the element to be configured on the first page based on the page rendering information corresponding to the first page; and
displaying the element to be configured on the first page based on the element rendering information of the element to be configured on the first page.

5. The method according to claim 4, further comprising:
obtaining, in response to a trigger operation for switching from the first page to a third page, element rendering information of the element to be configured on the third page from page rendering information corresponding to the third page; and
switching display from the first page to the third page, and displaying the element to be configured on the third page based on the element rendering information of the element to be configured on the third page.

6. The method according to claim 1, wherein before the displaying, in response to a select operation on a target campaign template, an element to be configured that corresponds to the target campaign template, the method further comprises:
displaying, based on campaign application object information carried in a context injection parameter, candidate campaign templates corresponding to the campaign application object information, wherein the candidate campaign templates comprise the target campaign template, and the campaign application object information is used to represent an application object corresponding to the target campaign.

7. The method according to claim 6, wherein after the generating a campaign configuration file corresponding to the target campaign based on the campaign configuration information, the method further comprises:
verifying, in response to a submit operation for the campaign configuration file, the campaign configuration information in the campaign configuration file based on a verification condition corresponding to the campaign application object information carried in the context injection parameter.

8. The method according to claim 6, wherein after the displaying, in response to a select operation on a target campaign template, an element to be configured that corresponds to the target campaign template, the method further comprises:
processing, in response to a select operation on a target element to be configured, campaign configuration information corresponding to the target element to be configured, based on a linkage display mode, the verification condition, and/or a data transformation rule corresponding to the campaign application object information carried in the context injection parameter.

9. An electronic device, comprising:
a processing unit; and
a memory coupled to the processing unit and storing instructions, the instructions, when executed by the processing unit, causing the electronic device to:
display, in response to a select operation on a target campaign template, an element to be configured that corresponds to the target campaign template, wherein the element to be configured is used to represent campaign information that needs to be configured for a target campaign corresponding to the target campaign template;
receive campaign configuration information entered for the element to be configured; and
generate a campaign configuration file corresponding to the target campaign based on the campaign configuration information, wherein the campaign configuration file is applied to a terminal on which the target campaign is deployed.

10. The device according to claim 9, wherein the target campaign template is configured with a template file, page rendering information of the target campaign template on each of a plurality of pages is defined in the template file, and the displaying, in response to a select operation on a target campaign template, an element to be configured that corresponds to the target campaign template comprises:
obtaining page rendering information corresponding to a first page from the template file corresponding to the target campaign template in response to the select operation on the target campaign template; and
displaying, on the first page based on the page rendering information corresponding to the first page, the element to be configured that corresponds to the target campaign template.

11. The device according to claim 10, wherein an information configuration module corresponding to a second page is defined in page rendering information corresponding to the second page in the plurality of pages, the information configuration module is configured with a configuration module file, an element to be configured that corresponds to the information configuration module is defined in the configuration module file, and the element to be configured is used to represent campaign information that needs to be configured for the information configuration module.

12. The device according to claim 10, wherein the element to be configured is configured with an element file, element rendering information of the element to be configured on each of the plurality of pages is defined in the element file, and the displaying, on the first page based on the page rendering information corresponding to the first page, the element to be configured that corresponds to the target campaign template comprises:
obtaining element rendering information of the element to be configured on the first page based on the page rendering information corresponding to the first page; and
displaying the element to be configured on the first page based on the element rendering information of the element to be configured on the first page.

13. The device according to claim 12, the electronic device is caused to:
obtain, in response to a trigger operation for switching from the first page to a third page, element rendering information of the element to be configured on the third page from page rendering information corresponding to the third page; and
switch display from the first page to the third page, and displaying the element to be configured on the third page based on the element rendering information of the element to be configured on the third page.

14. The device according to claim 9, wherein before the displaying, in response to a select operation on a target campaign template, an element to be configured that corresponds to the target campaign template, the electronic device is caused to:
display, based on campaign application object information carried in a context injection parameter, candidate campaign templates corresponding to the campaign application object information, wherein the candidate campaign templates comprise the target campaign template, and the campaign application object information is used to represent an application object corresponding to the target campaign.

15. The device according to claim 14, wherein after the generating a campaign configuration file corresponding to the target campaign based on the campaign configuration information, the electronic device is caused to:
verify, in response to a submit operation for the campaign configuration file, the campaign configuration information in the campaign configuration file based on a verification condition corresponding to the campaign application object information carried in the context injection parameter.

16. The device according to claim 14, wherein after the displaying, in response to a select operation on a target campaign template, an element to be configured that corresponds to the target campaign template, the electronic device is caused to:
process, in response to a select operation on a target element to be configured, campaign configuration information corresponding to the target element to be configured, based on a linkage display mode, the verification condition, and/or a data transformation rule corresponding to the campaign application object information carried in the context injection parameter.

17. A computer-readable storage medium, wherein the computer-readable storage medium stores instructions therein, and the instructions, when run on a terminal device, cause the terminal device to:
display, in response to a select operation on a target campaign template, an element to be configured that corresponds to the target campaign template, wherein the element to be configured is used to represent campaign information that needs to be configured for a target campaign corresponding to the target campaign template;
receive campaign configuration information entered for the element to be configured; and
generate a campaign configuration file corresponding to the target campaign based on the campaign configuration information, wherein the campaign configuration file is applied to a terminal on which the target campaign is deployed.

18. The computer-readable storage medium according to claim 17, wherein the target campaign template is configured with a template file, page rendering information of the target campaign template on each of a plurality of pages is defined in the template file, and the displaying, in response to a select operation on a target campaign template, an element to be configured that corresponds to the target campaign template comprises:
obtaining page rendering information corresponding to a first page from the template file corresponding to the target campaign template in response to the select operation on the target campaign template; and
displaying, on the first page based on the page rendering information corresponding to the first page, the element to be configured that corresponds to the target campaign template.

19. The computer-readable storage medium according to claim 18, wherein an information configuration module corresponding to a second page is defined in page rendering information corresponding to the second page in the plurality of pages, the information configuration module is configured with a configuration module file, an element to be configured that corresponds to the information configuration module is defined in the configuration module file, and the element to be configured is used to represent campaign information that needs to be configured for the information configuration module.

20. The computer-readable storage medium according to claim 18, wherein the element to be configured is configured with an element file, element rendering information of the element to be configured on each of the plurality of pages is defined in the element file, and the displaying, on the first page based on the page rendering information corresponding to the first page, the element to be configured that corresponds to the target campaign template comprises:
obtaining element rendering information of the element to be configured on the first page based on the page rendering information corresponding to the first page; and
displaying the element to be configured on the first page based on the element rendering information of the element to be configured on the first page.
